(19) United States
(12) Patent Application Publication
(10) Pub. No.: US 2026/0014737 A1
(43) Pub. Date: Jan. 15, 2026

(54) MOLD DEVICE WITH HIGH-TEMPERATURE, HIGH-PRESSURE, AIRTIGHT CAVITY STRUCTURE

(71) Applicant: EVERFIT TECHNOLOGY CO., LTD., Changhua County (TW)

(72) Inventor: JEN-TZU YANG, Changhua County (TW)

(21) Appl. No.: 19/226,042

(22) Filed: Jun. 2, 2025

(30) Foreign Application Priority Data
Jul. 10, 2024 (TW) 113125743

(51) Int. Cl. B29C 44/58; B29C 33/00

(52) U.S. Cl. CPC B29C 44/58; B29C 33/0038; B29K 2905/12

(57) ABSTRACT

A mold device with a high-temperature, high-pressure, airtight cavity structure includes a lower mold, an airtight gasket, and an upper mold. The lower mold has a lower parting surface formed with multiple downward concave arc-shaped annular grooves and multiple upward convex annular protrusions. The airtight gasket is attached to the lower parting surface and formed with multiple downward concave annular frame portions and multiple upward convex annular frame portions. The upper mold has an upper parting surface formed with multiple downward convex annular protrusions and multiple upward concave arc-shaped annular grooves. When in use, a workpiece forming material is heated in a main cavity of the lower mold and a high-pressure gas is input into the main cavity, and the airtight gasket prevents gas leakage by means of slight deformation, thereby improving the stability of the forming quality of workpieces.

### FIELD OF THE INVENTION

The present invention relates to a mold device, and more particularly, to a mold device with a high-temperature, high-pressure, airtight cavity structure. The mold device can effectively prevent the leakage of a high-pressure gas in a main cavity used for forming workpieces and improve the stability of the forming quality of the workpieces.

### BACKGROUND OF THE INVENTION

For some molded workpieces or products, such as foam workpiece molding, the foaming material is injected into the mold cavity, the mold needs to be heated to more than 200° C., and 100-300 Pa high-pressure gas is input into the mold cavity to perform foaming of the workpiece. When the high-pressure gas in the mold cavity is leaking or depressurized, it will affect the quality or stability of the workpiece molding. Although conventional rubber/plastic rings or gaskets around the mold cavity have a good airtight effect, they cannot withstand high temperatures. Flexible metal frame-shaped flat gaskets can withstand high temperatures. However, after repeated opening and closing of the mold, the surface of the gasket is hardened after repeated clamping by the mold, and it is difficult to maintain full airtightness for a period of time due to the flat surface of the gasket. Frequent replacement of airtight gaskets results in a considerable burden on the cost of forming workpieces.

### SUMMARY OF THE INVENTION

The primary object of the present invention is to provide a mold device with a high-temperature, high-pressure, airtight cavity structure. The mold device comprises a lower mold, an airtight gasket, and an upper mold.

The lower mold includes a lower mold body made of steel. The lower mold body has a main cavity for forming a workpiece. A lower parting surface is defined from the main cavity to a periphery of the lower mold body. The lower parting surface includes an inner support surface segment surrounding the main cavity, an outer support surface segment, and an airtight support surface segment between the inner support surface segment and the outer support surface segment. The airtight support surface segment has a plurality of downward concave arc-shaped annular grooves and a plurality of upward convex annular protrusions each connected between every adjacent two of the plurality of downward concave arc-shaped annular grooves.

The airtight gasket includes a thin gasket body made of a flexible metal material. The thin gasket body surrounds the main cavity of the lower mold and is attached to the lower parting surface. The thin gasket body has an inner gasket lip and an outer gasket lip corresponding to the inner support surface segment and the outer support surface segment, and an airtight gasket frame connected between the inner gasket lip and the outer gasket lip. The airtight gasket frame has a plurality of downward concave annular frame portions that correspond to and are fitted in the respective downward concave arc-shaped annular grooves and a plurality of upward convex annular frame portions each connected between every adjacent two of the plurality of downward concave annular frame portions and being matched with the respective upward convex annular protrusions.

The upper mold includes an upper mold body made of steel. The upper mold body has an upper cavity. The upper cavity and the main cavity of the lower mold constitute a workpiece forming cavity. An upper parting surface is defined from the upper cavity to a periphery of the upper mold body. The upper parting surface includes an inner pressing surface segment surrounding the upper cavity, an outer pressing surface segment, and an airtight pressing surface segment between the inner pressing surface segment and the outer pressing surface segment. The inner pressing surface segment and the outer pressing surface segment are configured for pressing the inner gasket lip and the outer gasket lip of the airtight gasket. The airtight pressing surface segment has a plurality of downward convex annular protrusions configured for pressing the respective downward concave annular frame portions and a plurality of upward concave arc-shaped annular grooves each connected between every adjacent two of the plurality of downward convex annular protrusions and configured for clamping the respective upward convex annular frame portions.

The mold device is mounted on a mold frame. The lower mold and the upper mold of the mold device are opened and closed by an actuator. When the mold device is in an open state, the workpiece forming material will be injected into the main cavity of the lower mold. The workpiece is formed after the mold device is closed. In the forming process of the workpiece in the main cavity, the mold device is heated and a high-pressure gas is input into the main cavity. The lower parting surface of the lower mold supports the airtight gasket. The clamping force of the actuator is applied to the upper mold. The upper parting surface forcefully presses the airtight gasket. The curved surface of the airtight gasket frame matches the airtight support surface segment of the lower parting surface and is pressed by the curved surface of the airtight pressing surface segment of the upper parting surface to achieve an airtight effect by means of slight deformation, so as to effectively prevent or stop the leakage of the high-pressure gas in the main cavity for a period of time, thereby improving the stability of the forming quality of the workpieces.

Preferably, the lower mold body and the upper mold body of the lower mold and the upper mold are made of steel or stainless steel with a Rockwell hardness of HRC20 or above, and the thin gasket body of the airtight gasket is made of copper or aluminum with a Rockwell hardness of HRC20 or below. The lower parting surface of the lower mold and the upper parting surface of the upper mold have a higher hardness and jointly clamp the airtight gasket with a lower hardness, so that the thin gasket body of the airtight gasket can be slightly deformed to provide better airtightness between the lower parting surface and the upper parting surface.

Preferably, the thin gasket body of the airtight gasket has a thickness of 0.5 to 2 mm. The thin gasket body with a sufficient thickness can withstand the clamping of the lower parting surface and the upper parting surface by means of slight deformation without excessive material consumption and is not prone to fatigue.

Preferably, in a cross-sectional shape of the airtight gasket, upper surfaces of the inner gasket lip and the outer gasket lip are flush with each other, thereby defining a reference line. Each of the downward concave annular frame portions of the airtight gasket frame is a downward concave semicircular frame portion having a downward concave inner diameter and a downward concave outer diameter both established on the reference line according to a thickness of the thin gasket body. Each of the upward convex annular frame portions of the airtight gasket frame is an upward convex semicircular frame portion having an upward convex inner diameter and an upward convex outer diameter both established on the reference line according to the thickness of the thin gasket body. The upward convex outer diameter of the upward convex annular frame portion corresponds to the downward concave inner diameter of the downward concave annular frame portion. In a cross-sectional shape of the lower parting surface of the lower mold, the inner support surface segment and the outer support surface segment are flush with each other, thereby defining a support reference line according to the thickness of the thin gasket body of the airtight gasket. Each of the downward concave arc-shaped annular grooves of the airtight support surface segment is a downward concave semicircular annular groove for receiving a corresponding one of the downward concave annular frame portions, having a center point on the support reference line and a downward concave circular diameter corresponding to the downward concave outer diameter of the corresponding downward concave annular frame portion. Each of the upward convex annular protrusions of the airtight support surface segment is an upward convex semicircular annular protrusion that can be received by a corresponding one of the upward convex annular frame portions, having a center point on the support reference line and an upward convex circular diameter corresponding to the upward convex inner diameter of the corresponding upward convex annular frame portion. In a cross-sectional shape of the upper parting surface of the upper mold, the inner pressing surface segment and the outer pressing surface segment are flush with each other, thereby defining a pressing reference line. Each of the downward convex annular protrusions of the airtight pressing surface segment is a downward convex semicircular annular protrusion that can be received by a corresponding one of the downward concave annular frame portions, having a center point on the pressing reference line and a downward convex circular diameter corresponding to the downward concave inner diameter of the corresponding downward concave annular frame portion. Each of the upward concave arc-shaped annular grooves of the airtight pressing surface segment is an upward concave semicircular annular groove for receiving a corresponding one of the upward convex annular frame portions, having a center point on the pressing reference line and an upward concave circular diameter corresponding to the upward convex outer diameter of the corresponding upward convex annular frame portion. The downward concave arc-shaped annular grooves and the upward convex annular protrusions of the lower parting surface support the downward concave annular frame portions and the upward convex annular frame portions by means of an extended curved surface, and the downward convex annular protrusions and the upward concave arc-shaped annular grooves of the upper parting surface press the downward concave annular frame portions and the upward convex annular frame portions of the airtight gasket by means of an extended curved surface, such that the airtight gasket is located between the lower parting surface and the upper parting surface and can be clamped and sealed by means of the extended curved surfaces, thereby providing an excellent airtight effect. The downward convex circular diameter of the downward convex annular protrusion of the airtight pressing surface segment is slightly larger than the downward concave inner diameter of the downward concave annular frame portion, and the upward concave circular diameter of the upward concave arc-shaped annular groove is slightly smaller than the upward convex outer diameter of the upward convex annular frame portion, such that the downward convex annular protrusions and the upward concave arc-shaped annular grooves press the downward concave annular frame portions and the upward convex annular frame portions to provide a tightening effect. The airtight gasket is disposed reversely between the lower parting surface and the upper parting surface. The cross-sectional shape of the airtight support surface segment of the lower parting surface and the cross-sectional shape of the airtight pressing surface segment of the upper parting surface are matched with the reversed airtight gasket in a manner where their original cross-sectional shapes are exchanged according to the reversed the airtight gasket. When the airtight gasket is disposed reversely, only the cross-sectional shape of the airtight support surface segment and the cross-sectional shape of the airtight pressing surface segment need to be adapted accordingly, such that the front or back of the airtight gasket can be selectively used, depending on the design of the main cavity of the mold device.

### BRIEF DESCRIPTION OF THE DRAWINGS

FIG. 1 is a perspective view of the present invention;

FIG. 2 is an exploded view of the present invention;

FIG. 3 is a cross-sectional view of the present invention;

FIG. 4 is an enlarged view of circle A in FIG. 3;

FIG. 5 is a schematic view showing the structural relationship between the upper and lower parting surfaces and the airtight gasket of the present invention;

FIG. 6 is a perspective view of the mold device of the invention installed on a mold frame in an open state;

FIG. 7 is a perspective view of the mold device of the invention installed on a mold frame in a closed state;

FIG. 8 is a schematic view of the high-temperature, high-pressure, airtight cavity structure of the present invention;

FIG. 9 is a cross-sectional view of another embodiment of the present invention; and

FIG. 10 is an enlarged view of circle B in FIG. 9.

### DETAILED DESCRIPTION OF THE PREFERRED EMBODIMENTS

Embodiments of the present invention will now be described, by way of example only, with reference to the accompanying drawings.

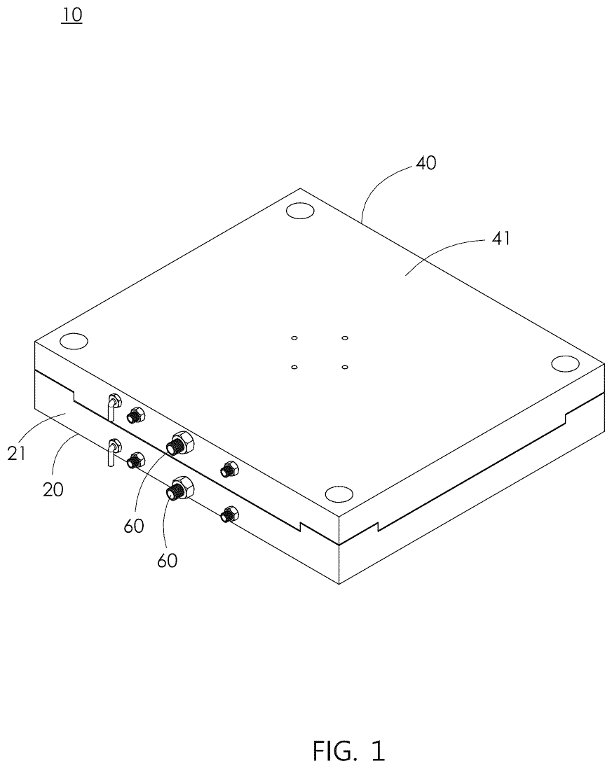

As shown in FIG. 1 through FIG. 5, the present invention discloses a mold device 10 with a high-temperature, high-pressure, airtight cavity structure, comprising a lower mold 20, an airtight gasket 30, and an upper mold 40.

The lower mold 20 includes a lower mold body 21 made of steel. The lower mold body 21 has a main cavity 22 for forming a workpiece. A lower parting surface 23 is defined from the main cavity 22 to the periphery of the lower mold body 21. The lower parting surface 23 includes an inner support surface segment 24 surrounding the main cavity 22, an outer support surface segment 25, and an airtight support surface segment 26 between the inner support surface segment 24 and the outer support surface segment 25. The airtight support surface segment 26 has a plurality of downward concave arc-shaped annular grooves 27 and a plurality of upward convex annular protrusions 28 each connected between every adjacent two of the plurality of downward concave arc-shaped annular grooves 27.

The airtight gasket 30 includes a thin gasket body 300 made of a flexible metal material. The thin gasket body 300 surrounds the main cavity 22 of the lower mold 20 and is attached to the lower parting surface 23. The thin gasket body 300 has an inner gasket lip 31 and an outer gasket lip 32 corresponding to the inner support surface segment 24 and the outer support surface segment 25, and an airtight gasket frame 33 connected between the inner gasket lip 31 and the outer gasket lip 32. The airtight gasket frame 33 has a plurality of downward concave annular frame portions 34 that correspond to and are fitted in the respective downward concave arc-shaped annular grooves 27 and a plurality of upward convex annular frame portions 35 each connected between every adjacent two of the plurality of downward concave annular frame portions 34 and being matched with the respective upward convex annular protrusions 28.

The upper mold 40 includes an upper mold body 41 made of steel. The upper mold body 41 has an upper cavity 42. The upper cavity 42 and the main cavity 22 of the lower mold 20 constitute a workpiece forming cavity. An upper parting surface 43 is defined from the upper cavity 42 to the periphery of the upper mold body 41. The upper parting surface 43 includes an inner pressing surface segment 44 surrounding the upper cavity 42, an outer pressing surface segment 45, and an airtight pressing surface segment 46 between the inner pressing surface segment 44 and the outer pressing surface segment 45. The inner pressing surface segment 44 and the outer pressing surface segment 45 are configured for pressing the inner gasket lip 31 and the outer gasket lip 32 of the airtight gasket 30. The airtight pressing surface segment 46 has a plurality of downward convex annular protrusions 47 configured for pressing the respective downward concave annular frame portions 34 and a plurality of upward concave arc-shaped annular grooves 48 each connected between every adjacent two of the plurality of downward convex annular protrusions 47 and configured for clamping the respective upward convex annular frame portions 35.

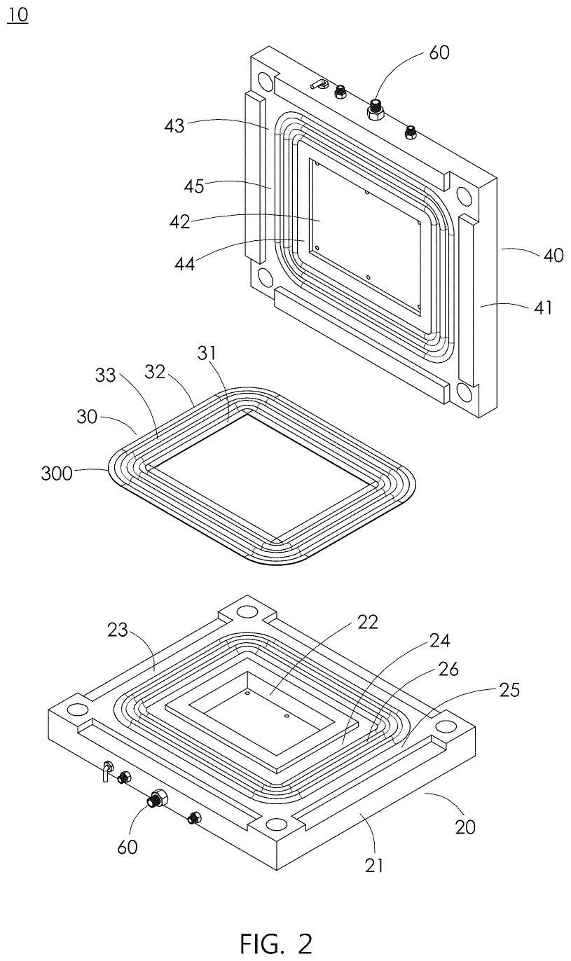

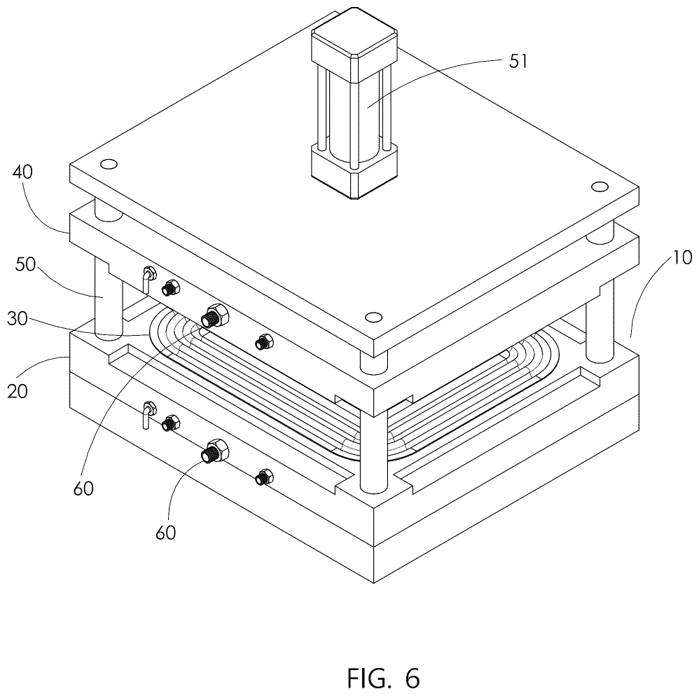

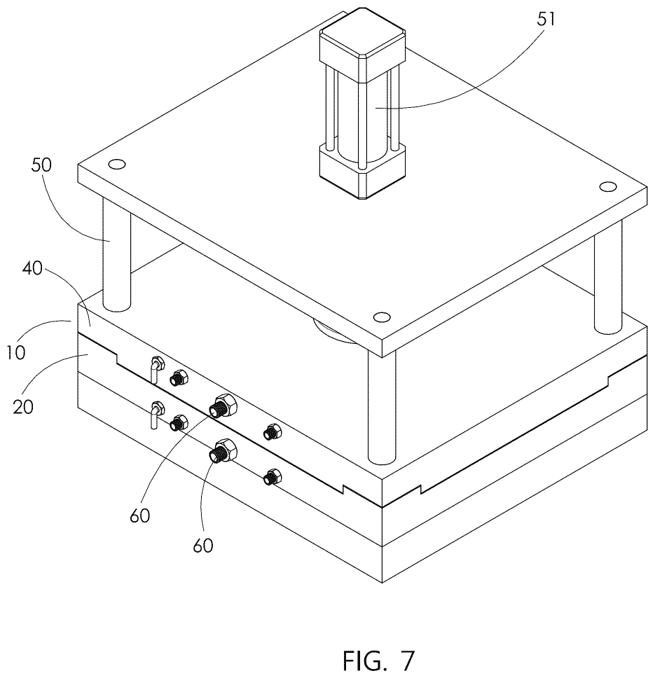

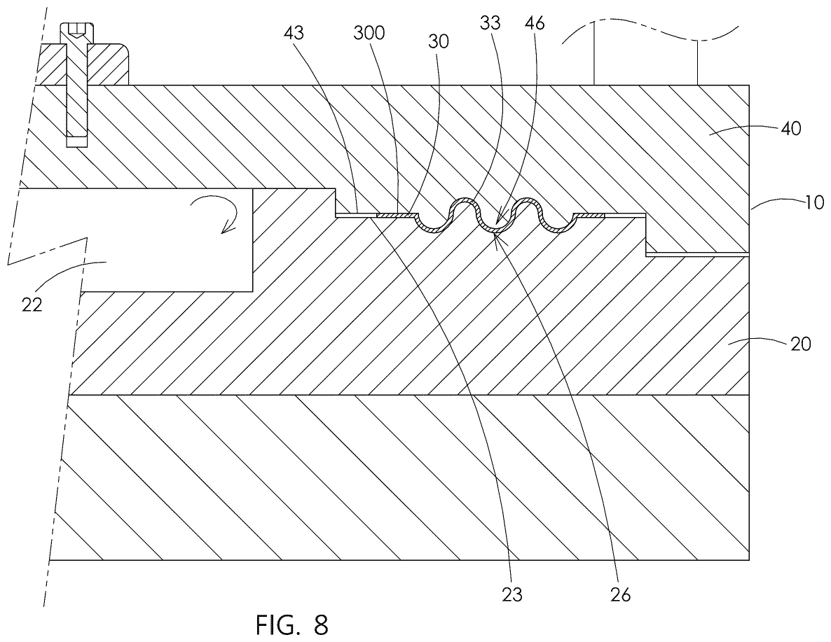

As shown in FIG. 6 and FIG. 7, the lower mold 20 and the upper mold 40 of the mold device 10 are mounted on a mold frame 50. The lower mold 20 and the upper mold 40 of the mold device 10 are opened and closed by an actuator 51. As shown in FIG. 6, when the mold device is in an open state, the workpiece forming material (not shown) will be injected into the main cavity 22 (as shown in FIG. 2) of the lower mold 20. As shown in FIG. 7, the workpiece is formed after the mold device is closed. As shown in FIG. 8, in the process of forming a workpiece (not shown) in the main cavity 22, the mold device 10 is heated (e.g., by an electric heating tube) and a high-pressure gas is input into the main cavity 22. As shown in FIG. 7, high-pressure nitrogen is supplied through a gas supply fitting 60. The lower parting surface 23 of the lower mold 20 supports the airtight gasket 30. The clamping force of the actuator 51 (as shown in FIG. 7) is applied to the upper mold 40. The upper parting surface 43 forcefully presses the airtight gasket 30. The curved surface (long-distance curved surface) of the airtight gasket frame 33 matches the airtight support surface segment 26 of the lower parting surface 23 and is pressed by the curved surface (long-distance curved surface) of the airtight pressing surface segment 46 of the upper parting surface 43 to achieve an airtight effect by means of slight deformation, so as to effectively (durably) prevent or stop the leakage of the high-pressure gas in the main cavity 22 (i.e., the mold cavity) for a period of time, thereby improving the stability of the forming quality of the workpieces.

According to the above embodiment, preferably, as shown in FIG. 1 and FIG. 2, the lower mold body 21 and the upper mold body 41 of the lower mold 20 and the upper mold 40 are made of steel or stainless steel with a Rockwell hardness of HRC20 or above, and the thin gasket body 300 of the airtight gasket 30 is made of copper (such as red copper) or aluminum (including aluminum alloy) with a Rockwell hardness of HRC20 or below. As shown in FIG. 8, the lower parting surface 23 of the lower mold 20 and the upper parting surface 43 of the upper mold 40 have a higher hardness and jointly clamp the airtight gasket 30 with a lower hardness, so that the thin gasket body 300 of the airtight gasket 30 can be slightly deformed to provide better airtightness between the lower parting surface 23 and the upper parting surface 43.

According to the above embodiment, preferably, as shown in FIG. 2, the thickness of the thin gasket body 300 of the airtight gasket 30 is 0.5 to 2 mm. As shown in FIG. 8, the thin gasket body 300 with a sufficient thickness can withstand the clamping of the lower parting surface 23 and the upper parting surface 43 by means of slight deformation without excessive material consumption and is not prone to fatigue.

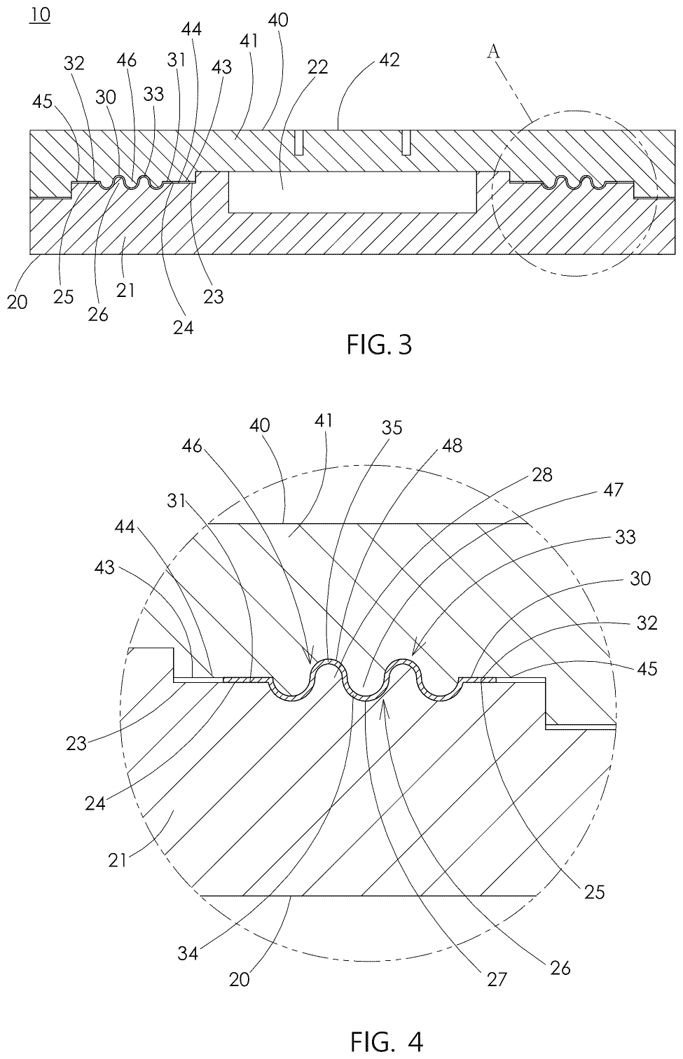

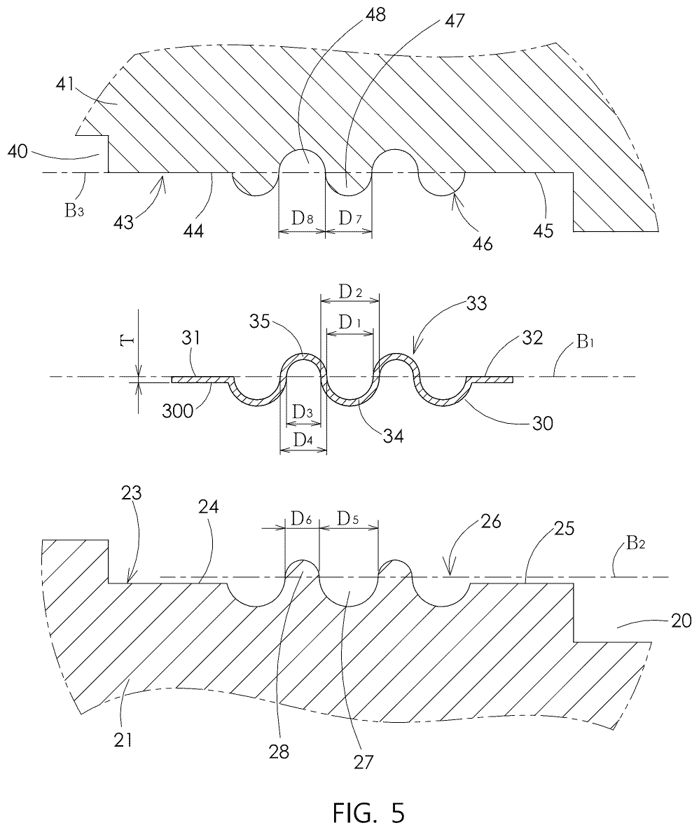

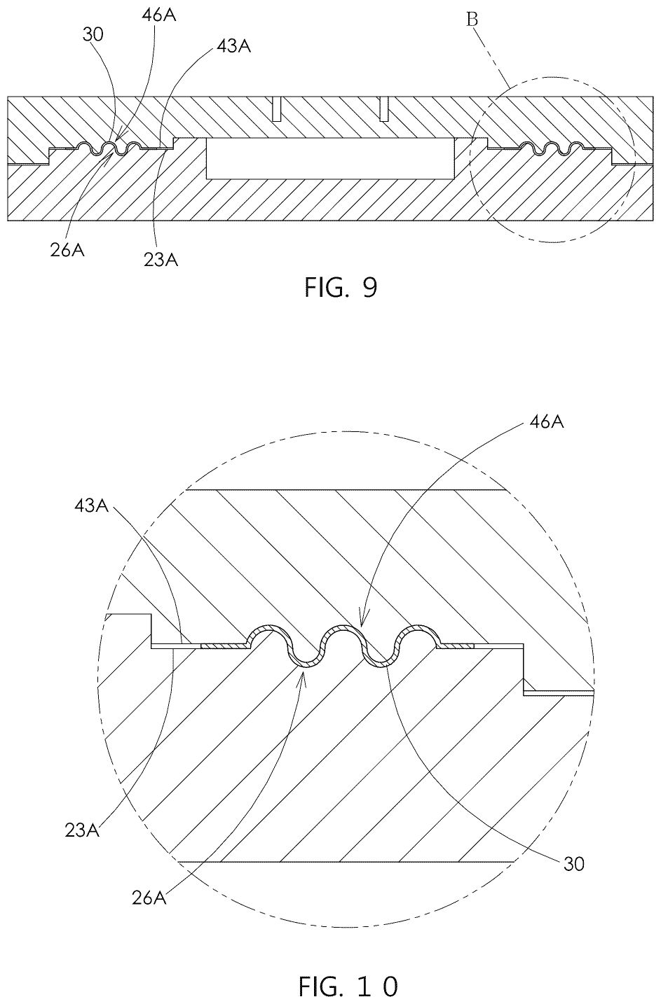

According to the above embodiment, preferably, as shown in FIG. 3, FIG. 4 and FIG. 5, in the cross-sectional shape of the airtight gasket 30, the upper surfaces of the inner gasket lip 31 and the outer gasket lip 32 are flush with each other, thereby defining a reference line B₁. Each of the downward concave annular frame portions 34 of the airtight gasket frame 33 is a downward concave semicircular frame portion having a downward concave inner diameter D₁ and a downward concave outer diameter D₂ (D₂=D₁+2T) both established on the reference line B₁ according to the thickness T of the thin gasket body 300. Each of the upward convex annular frame portions 35 of the airtight gasket frame 33 is an upward convex semicircular frame portion having an upward convex inner diameter D₃ and an upward convex outer diameter D₄ (D₄=D₃+2T) both established on the reference line B₁ according to the thickness T of the thin gasket body 300. The upward convex outer diameter D₄ of the upward convex annular frame portion 35 corresponds to the downward concave inner diameter D₁ of the downward concave annular frame portion 34 (namely, D₄=D₁). In the cross-sectional shape of the lower parting surface 23 of the lower mold 20, the inner support surface segment 24 and the outer support surface segment 25 are flush with each other, thereby defining a support reference line B₂ according to the thickness T of the thin gasket body 300 of the airtight gasket 30. Each of the downward concave arc-shaped annular grooves 27 of the airtight support surface segment 26 is a downward concave semicircular annular groove for receiving the downward concave annular frame portion 34, having a center point on the support reference line B₂ and a downward concave circular diameter D₅ corresponding to the downward concave outer diameter D₂ of the downward concave annular frame portion 34. Each of the upward convex annular protrusions 28 of the airtight support surface segment 26 is an upward convex semicircular annular protrusion that can be received by the upward convex annular frame portion 35, having a center point on the support reference line B₂ and an upward convex circular diameter D₆ corresponding to the upward convex inner diameter D₃ of the upward convex annular frame portion 35. In the cross-sectional shape of the upper parting surface 43 of the upper mold 40, the inner pressing surface segment 44 and the outer pressing surface segment 45 are flush with each other, thereby defining a pressing reference line B₃. Each of the downward convex annular protrusions 47 of the airtight pressing surface segment 46 is a downward convex semicircular annular protrusion that can be received by the downward concave annular frame portion 34, having a center point on the pressing reference line B₃ and a downward convex circular diameter D₇ corresponding to the downward concave inner diameter D₁ of the downward concave annular frame portion 34. Each of the upward concave arc-shaped annular grooves 48 of the airtight pressing surface segment 46 is an upward concave semicircular annular groove for receiving the upward convex annular frame portion 35, having a center point on the pressing reference line B₃ and an upward concave circular diameter D₈ corresponding to the upward convex outer diameter D₄ of the upward convex annular frame portion 35. The downward concave arc-shaped annular grooves 27 and the upward convex annular protrusions 28 on the lower parting surface 23 support the downward concave annular frame portions 34 and the upward convex annular frame portions 35 by means of an extended curved surface, and the downward convex annular protrusions 47 and the upward concave arc-shaped annular grooves 48 on the upper parting surface 43 press the downward concave annular frame portions 34 and the upward convex annular frame portions 35 of the airtight gasket 30 by means of an extended curved surface, such that the airtight gasket 30 is located between the lower parting surface 23 and the upper parting surface 43 and can be clamped and sealed by means of the extended curved surfaces, thereby providing an excellent airtight effect. The downward convex circular diameter D₇ of the downward convex annular protrusion 47 of the airtight pressing surface segment 46 is slightly larger than the downward concave inner diameter D₁ of the downward concave annular frame portion 34, preferably, by 0.01-0.03 mm, and the upward concave circular diameter D₈ of the upward concave arc-shaped annular groove 48 is slightly smaller than the upward convex outer diameter D₄ of the upward convex annular frame portion 35, preferably, by 0.01-0.03 mm, such that the downward convex annular protrusions 47 and the upward concave arc-shaped annular grooves 48 press the downward concave annular frame portions 34 and the upward convex annular frame portions 35 to provide a tightening effect. As shown in FIG. 9 and FIG. 10, the airtight gasket 30 is disposed reversely (i.e., the reverse side in FIG. 3 and FIG. 4) between the lower parting surface 23A and the upper parting surface 43A. The cross-sectional shape of the airtight support surface segment 26A of the lower parting surface 23A and the cross-sectional shape of the airtight pressing surface segment 46A of the upper parting surface 43A are matched with the reversed airtight gasket 30 in a manner where their original cross-sectional shapes (as shown in in FIG. 3 and FIG. 4) are exchanged according to the reversed airtight gasket 30. When the airtight gasket 30 is disposed reversely, only the cross-sectional shape of the airtight support surface segment 26A and the cross-sectional shape of the airtight pressing surface segment 46A need to be adapted accordingly, such that the front or back of the airtight gasket 30 can be selectively used, depending on the design (variation or difference) of the main cavity 22 (mold cavity) of the mold device 10.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A mold device with a high-temperature, high-pressure, airtight cavity structure, comprising:
a lower mold, including a lower mold body made of steel, the lower mold body having a main cavity for forming a workpiece, a lower parting surface being defined from the main cavity to a periphery of the lower mold body, the lower parting surface including an inner support surface segment surrounding the main cavity, an outer support surface segment, and an airtight support surface segment between the inner support surface segment and the outer support surface segment, the airtight support surface segment having a plurality of downward concave arc-shaped annular grooves and a plurality of upward convex annular protrusions each connected between every adjacent two of the plurality of downward concave arc-shaped annular grooves;
an airtight gasket, including a thin gasket body made of a flexible metal material, the thin gasket body surrounding the main cavity of the lower mold and being attached to the lower parting surface, the thin gasket body having an inner gasket lip and an outer gasket lip corresponding to the inner support surface segment and the outer support surface segment, and an airtight gasket frame connected between the inner gasket lip and the outer gasket lip, the airtight gasket frame having a plurality of downward concave annular frame portions that correspond to and are fitted in the respective downward concave arc-shaped annular grooves and a plurality of upward convex annular frame portions each connected between every adjacent two of the plurality of downward concave annular frame portions and being matched with the respective upward convex annular protrusions;
an upper mold, including an upper mold body made of steel, the upper mold body having an upper cavity, the upper cavity and the main cavity of the lower mold constituting a workpiece forming cavity, an upper parting surface being defined from the upper cavity to a periphery of the upper mold body, the upper parting surface including an inner pressing surface segment surrounding the upper cavity, an outer pressing surface segment, and an airtight pressing surface segment between the inner pressing surface segment and the outer pressing surface segment, the inner pressing surface segment and the outer pressing surface segment being configured for pressing the inner gasket lip and the outer gasket lip of the airtight gasket, the airtight pressing surface segment having a plurality of downward convex annular protrusions configured for pressing the respective downward concave annular frame portions and a plurality of upward concave arc-shaped annular grooves each connected between every adjacent two of the plurality of downward convex annular protrusions and configured for clamping the respective upward convex annular frame portions.

2. The mold device as claimed in claim 1, wherein the lower mold body and the upper mold body of the lower mold and the upper mold are made of steel or stainless steel with a Rockwell hardness of HRC20 or above, and the thin gasket body of the airtight gasket is made of copper or aluminum with a Rockwell hardness of HRC20 or below.

3. The mold device as claimed in claim 1, wherein the thin gasket body of the airtight gasket has a thickness of 0.5 to 2 mm.

4. The mold device as claimed in claim 1, wherein in a cross-sectional shape of the airtight gasket, upper surfaces of the inner gasket lip and the outer gasket lip are flush with each other, thereby defining a reference line, each of the downward concave annular frame portions of the airtight gasket frame is a downward concave semicircular frame portion having a downward concave inner diameter and a downward concave outer diameter both established on the reference line according to a thickness of the thin gasket body, each of the upward convex annular frame portions of the airtight gasket frame is an upward convex semicircular frame portion having an upward convex inner diameter and an upward convex outer diameter both established on the reference line according to the thickness of the thin gasket body, the upward convex outer diameter of the upward convex annular frame portion corresponds to the downward concave inner diameter of the downward concave annular frame portion; in a cross-sectional shape of the lower parting surface of the lower mold, the inner support surface segment and the outer support surface segment are flush with each other, thereby defining a support reference line according to the thickness of the thin gasket body of the airtight gasket, each of the downward concave arc-shaped annular grooves of the airtight support surface segment is a downward concave semicircular annular groove for receiving a corresponding one of the downward concave annular frame portions, having a center point on the support reference line and a downward concave circular diameter corresponding to the downward concave outer diameter of the corresponding downward concave annular frame portion, each of the upward convex annular protrusions of the airtight support surface segment is an upward convex semicircular annular protrusion that can be received by a corresponding one of the upward convex annular frame portions, having a center point on the support reference line and an upward convex circular diameter corresponding to the upward convex inner diameter of the corresponding upward convex annular frame portion; in a cross-sectional shape of the upper parting surface of the upper mold, the inner pressing surface segment and the outer pressing surface segment are flush with each other, thereby defining a pressing reference line, each of the downward convex annular protrusions of the airtight pressing surface segment is a downward convex semicircular annular protrusion that can be received by a corresponding one of the downward concave annular frame portions, having a center point on the pressing reference line and a downward convex circular diameter corresponding to the downward concave inner diameter of the corresponding downward concave annular frame portion, each of the upward concave arc-shaped annular grooves of the airtight pressing surface segment is an upward concave semicircular annular groove for receiving a corresponding one of the upward convex annular frame portions, having a center point on the pressing reference line and an upward concave circular diameter corresponding to the upward convex outer diameter of the corresponding upward convex annular frame portion.

5. The mold device as claimed in claim 4, wherein the downward convex circular diameter of the downward convex annular protrusion of the airtight pressing surface segment is slightly larger than the downward concave inner diameter of the downward concave annular frame portion, and the upward concave circular diameter of the upward concave arc-shaped annular groove is slightly smaller than the upward convex outer diameter of the upward convex annular frame portion.

6. The mold device as claimed in claim 5, wherein the downward convex circular diameter of the downward convex annular protrusion is larger than the downward concave inner diameter of the downward concave annular frame portion by 0.01-0.03 mm; the upward concave circular diameter of the upward concave arc-shaped annular groove is smaller than the upward convex outer diameter of the upward convex annular frame portion by 0.01-0.03 mm.

7. The mold device as claimed in claim 4, wherein the airtight gasket is disposed reversely between the lower parting surface and the upper parting surface, and the cross-sectional shape of the airtight support surface segment of the lower parting surface and the cross-sectional shape of the airtight pressing surface segment of the upper parting surface are matched with the reversed airtight gasket in a manner where their original cross-sectional shapes are exchanged according to the reversed the airtight gasket.
